(19) United States
(12) Patent Application Publication
(10) Pub. No.: US 2005/0277716 A1
(43) Pub. Date: Dec. 15, 2005

(54) Furyl-2-methylidene UV absorbers and compositions incorporating the UV absorbers

(76) Inventors: Jason Clay Pearson, Kingsport, TN (US); Dale Milton Blakely, Kingsport, TN (US); Frederick Leslie Colhoun, Kingsport, TN (US); Max Allen Weaver, Kingsport, TN (US)

Correspondence Address: Dennis V. Carmen;Eastman Chemical Company, P.O. Box 511, Kingsport, TN, 37662-5075, US

(21) Appl. No.: 10/855,612

(22) Filed: May 27, 2004

(51) Int. Cl. C08K 5/34

(52) U.S. Cl. 524/111

(57) ABSTRACT

A method for efficiently incorporating a UV absorber into a polyester resin. The method includes forming a reaction mixture comprising a diol component, a diacid component selected from the group consisting of dicarboxylic acids, dicarboxylic acid derivatives, and mixtures thereof, an antimony containing compound, a phosphorus containing compound, a metal containing compound, and a UV absorber. The reaction mixture is polymerized in a polycondensation reaction system. In another embodiment of the present invention, the UV absorber is added while the reaction products from one reactor are transferred to the next reactor in the polycondensation reaction system. The present invention is also directed to novel UV absorbing compounds as well as articles made from the polyester resin.

### BACKGROUND OF THE INVENTION

1. Field of the Invention

The present invention relates to UV absorbing compounds, methods for efficiently incorporating the UV absorbing compounds into a polyester composition, and to polyester compositions having the UV absorbing compounds made by the methods. More particularly, the present invention relates to furyl methine UV absorbing compounds and a method for incorporating the furyl methine UV absorbers into a polyester composition.

2. Background Art

Polyester is a polymeric resin widely used in a number of packaging and fiber based applications. Poly(ethylene terephthalate) (“PET”) or a modified PET is the polymer of choice for making beverage and food containers such as plastic bottles and jars used for carbonated beverages, water, juices, foods, detergents, cosmetics, and other products.

In the typical polyester forming polycondensation reaction, a diol such as ethylene glycol is reacted with a dicarboxylic acid or a dicarboxylic acid ester. The reaction is accelerated by the addition of a suitable reaction catalyst. Since the product of the polyester condensation reaction tends to be reversible and in order to increase the molecular weight of the polyesters, this reaction is often carried out in a multi-chamber polycondensation reaction system having several reaction chambers operating in series. Typically, the diol and the dicarboxylic acid component are introduced in the first reactor at a relatively high pressure. After polymerizing at an elevated temperature the resulting polymer is then transferred to the second reaction chamber which is operated at a lower pressure than the first chamber. The polymer continues to grow in this second chamber with volatile compounds being removed. This process is repeated successively for each reactor, each of which are operated at lower and lower pressures. The result of this step wise condensation is the formation of polyester with higher molecular weight and higher inherent viscosity.

During the polycondensation process, various additives such as colorants and ultraviolet light (UV) absorbers may be added. UV absorbers are a particularly important additive, both for imparting stability to the polyesters and to protect those products packaged in PET containers from degradation induced by exposure to UV light. U.S. Pat. No. 4,617,374 (hereinafter '374 patent) discloses the use of certain UV-absorbing methine compounds that may be incorporated in a polyester or a polycarbonate during polycondensation. These compounds enhance ultraviolet or visible light absorption with a maximum absorbance within the range of from about 320 nm to about 380 nm. Functionally, these compounds contain an acid or ester group which condenses onto the polymer chain as a terminator. Moreover, the UV absorbers of the '374 patent have been found to be useful in the preparation of polyesters such as poly(ethylene terephthalate) and copolymers of poly(ethylene terephthalate) and poly(1,4-cyclohexylenedimethylene terephthalate). It has been observed, however, that some UV absorbers are somewhat volatile causing the yield of these UV absorbers in the formed polyester to be somewhat less than 100% (values of 80% to 85% are typical). Moreover, these compounds may plug the equipment by condensing in the process lines. The loss of UV absorber results in added costs for the polyester formation because of the down time needed to clean process lines and because of the relatively high cost of these compounds.

Accordingly, there is a need for improved methods of incorporating UV absorbers into polyester compositions made by the melt phase polycondensation method, and/or improved polyester compositions containing UV absorbers.

### SUMMARY OF THE INVENTION

The present invention overcomes the problems of the prior art by providing a method for incorporating a UV absorber into a polyester resin.

In one embodiment of the invention, a method comprises forming a reaction mixture substantially free of a titanium containing ester exchange catalyst compound and comprising combining a diol, a diacid component selected from the group consisting of dicarboxylic acids, dicarboxylic acid derivatives, and mixtures thereof, an antimony containing compound in an amount of less than 0.1% of the total weight of the reaction mixture, a phosphorus containing compound present in an amount of less than about 0.1% of the total weight of the reaction mixture, a metal containing compound selected from the group consisting of zinc containing compounds and/or manganese containing compounds, present in an amount from about 10 ppm to about 300 ppm, and a UV absorber with polyester reactive moieties. The antimony containing compound, the phosphorus containing compound, and the metal-containing compound comprise the catalyst system used to promote the condensation polymerization that occurs in the method of the invention. The reaction mixture is then polymerized in a polycondensation reaction system in the absence of the titanium ester exchange catalyst compound. The polycondensation reaction system is characterized by having a first reaction chamber, a last reaction chamber, and optionally one or more intermediate reaction chambers between the first reaction chamber and the last reaction chamber. The reaction system is operated in series such that the reaction mixture is progressively polymerized in the first reaction chamber, the one or more intermediate reactions, and the last reaction chamber. Accordingly, as the reaction mixture proceeds through the series of reaction chambers, polymerization occurs and a polyester is formed by the condensation reaction of the diol and the diacid component. Moreover, volatile compounds are removed in each reaction chamber and the average molecular weight of the polyester increases from reactor to reactor by the decreasing reaction pressures of the successive reaction chambers.

In another embodiment of the present invention, a method of incorporating a UV absorber in a polyester composition is provided. The method of this embodiment comprises.
a) forming a reaction mixture comprising combining:
   a diol,
   a diacid component selected from the group consisting of dicarboxylic acids, dicarboxylic acid derivatives, and mixtures thereof in a polycondensation reaction system comprising a series of reaction chambers designated as reaction chamber RCⁱ having a first reaction chamber designated as reaction chamber RC¹, a last reaction chamber designated as reaction chamber RC^{k}, and one or more intermediate reaction chambers
b) successively polymerizing the reaction mixture in the multichamber polymerization system wherein the reaction system is operated in series such that a reaction product designated as product Pⁱ from reaction chamber RCⁱ is transportable to reaction chamber RCⁱ⁺¹ by a conduit designated as conduit Cⁱ connecting reaction chamber RCⁱ to reaction chamber RCⁱ⁺¹; and
c) adding the UV absorber to reaction product Pⁱ as it is transported from reaction chamber RCⁱ to reaction chamber RCⁱ⁺¹,
   wherein i and k are integers and k is the total number of reaction chambers.

In another embodiment of the present invention, a titanium metal free polyester composition is provided. The titanium free polyester composition of this embodiment comprises a diol residue, as diacid residue, a UV absorber residue, antimony atoms, phosphorus atoms, and metal atoms selected from the group consisting of zinc, manganese, and mixtures thereof. The antimony, phosphorus, and metal atoms represent the residue of the catalyst system used to promote the condensation polymerization that forms the polyester composition.

In yet another embodiment of the present invention, an article made from the polyester is provided.

Yet another embodiment of the present invention are novel furyl methine UV absorbing compounds that can be incorporated into a PET polyester and articles made therefrom.

### DETAILED DESCRIPTION OF THE PREFERRED EMBODIMENT(S)

Reference will now be made in detail to presently preferred compositions or embodiments and methods of the invention, which constitute the best modes of practicing the invention presently known to the inventors.

The term “residue” as used herein, refers to the portion of a compound that is incorporated into a polyester composition.

In an embodiment of the present invention, a method of incorporating a UV absorber into a polyester resin is provided. The method of this embodiment comprises forming a reaction mixture substantially free of a titanium containing ester exchange catalyst compound and comprising a diol, a diacid component selected from the group consisting of dicarboxylic acids, dicarboxylic acid derivatives, and mixtures thereof, an antimony containing compound in an amount of less than 0.1% of the total weight of the reaction mixture, a phosphorus containing compound present in an amount of less than about 0.1% of the total weight of the reaction mixture, a metal containing compound selected from the group consisting of zinc containing compounds, manganese containing compounds, present in an amount from about 10 ppm to about 300 ppm, and a UV absorber. We have found that polyester compositions can be made from reaction mixtures substantially free of titanium containing ester exchange catalysts with high yields of UV absorbers. While the mechanism to explain this phenomena is not fully understood, it is believed that the presence of titanium containing ester exchange compounds have such high conversion activity that the catalyst may also contribute to reactions which degrade some UV absorbers preventing the UV absorbers from absorbing, dissolving, or otherwise tying into the polyester polymer, or both. As used herein, the phrase “substantially free” or “in the absence of” does not preclude the presence of trace amounts of titanium containing compounds, and in this regard, the presence of 0 to about 5 ppm of titanium metal is considered a trace amount which can be found in the polyester composition made by what is considered to be a process conducted in the absence of a titanium containing ester exchange catalyst. Preferably, the process is conducted using compounds containing 2 ppm or less of titanium metal, and more preferably 0.0 ppm of titanium metal containing compounds are used in the process of the invention. Although it is desired to keep titanium metal to a minimum, of from 0 to about 5 ppm of titanium metal, desirably, less than 2 ppm can be added to the polyester composition and still be in accordance with the present invention. More desirably, 0.0 ppm of titanium metal is added to the polyester composition.

In this embodiment, the reaction mixture is then polymerized in a multi-chamber polymerization system. The polycondensation reaction system is characterized by having a first reaction chamber, a last reaction chamber, and one or more intermediate reaction chambers between the first reaction chamber and the last reaction chambers. The reaction system is operated in series such that the reaction mixture is progressively polymerized in the first reaction chamber, the one or more intermediate reactions, and the last reaction chamber. The UV absorber may be added at any point in the melt phase. The polyester removed from the last reaction chamber has an inherent viscosity from about 0.2 to about 0.75 dL/g. Finally, the reaction mixture is further characterized by having from 0.0 to about 5 ppm titanium containing atoms.

Broadly, the UV absorbers used in the method of the present invention include those disclosed in U.S. Pat. No. 4,749,772, the entire disclosure of which are hereby incorporated by reference. The UV absorbers are characterized by having at least one furyl-2-methylidene radical of Formula I present: 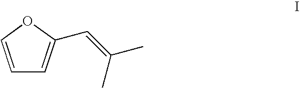
wherein the UV absorber includes a polyester reactive group.

Preferred compounds useful in the practice of the invention which contain the radical of Formula I include one or more of the compounds represented by Formulae II and III below: 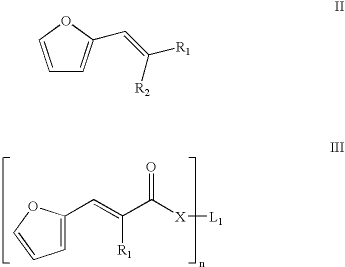
wherein:
X is selected from the group consisting of oxygen, —NH—, and —N(R′)—;
n is a whole number ranging from 2 to 4;
R₁ is selected from the group consisting of —CO₂R₃ and cyano;
R₂ is selected from the group consisting of cyano, —CO₂R₃, C₁-C₆-alkylsulfonyl, arylsulfonyl, carbamoyl, C₁-C₆-alkanoyl, aroyl, aryl, and heteroaryl;
R₃ is selected from the group consisting of hydrogen, C₁-C₁₂-alkyl, substituted C₁-C₁₂-alkyl, —(CHR′—CHR″O—)ₚCH₂CH₂R₄, C₃-C₈-alkenyl, C₃-C₈-cycloalkyl, aryl and cyano;
R₄ is selected from the group consisting of hydrogen, hydroxy, C₁-C₆-alkoxy, C₁-C₆-alkanoyloxy and aryloxy;
R′ and R″ are independently selected from hydrogen and C₁-C₁₂-alkyl;
L₁ is a di, tri, or tetravalent linking group, where the divalent radical is selected from the group consisting of C₂-C₁₂-alkylene, —(CHR′CHR″O—)ₚCHR′CHR″—, C₁-C₂-alkylene-arylene-C₁-C₂-alkylene, —CH₂CH₂O-arylene-OCH₂CH₂—, and —CH₂-1,4-cyclohexylene-CH₂—; where the trivalent and tetravalent radicals are selected from the group consisting of C₃-C₈ aliphatic hydrocarbon having three or four covalent bonds. Examples of trivalent and tetravalent radicals include —CH(—CH₂—)₂ and C(CH₂—)₄.

More preferred UV absorbers include those represented by the following Formulae IV-VI: 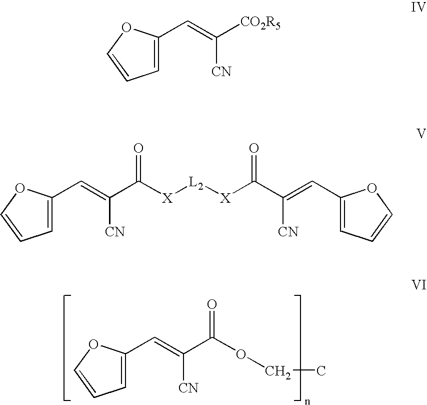
wherein:
X is as defined above;
R₅ is selected from the group consisting of C₁-C₆-alkyl, cyclohexyl, phenyl, and —(CHR′CHR″O—)ₚR₆;
R₆ is selected from hydrogen, C₁-C₆-alkoxy, and C₁-C₆-alkanoyloxy; and
L₂ is selected from the group consisting of C₂-C₆-alkylene, —(CHR′CHR″O—)ₚCHR′CHR″—, and —CH₂-cyclohexane-1,4-diyl-CH₂—.

The alkoxylated moiety denoted herein by the formula —(CHR′CHR″O—)ₚ has a chain length wherein p is from 1 to 100; preferably p is less than about 50; more preferably p is less than 8, and most preferably p is from 1-3. In a preferred embodiment the alkoxylated moiety comprises ethylene oxide residues, propylene oxide residues, or residues of both.

The term “C₁-C₁₂-alkyl” is used to denote an aliphatic hydrocarbon radical that contains one to twelve carbon atoms and is either a straight or a branched chain.

The term “substituted C₁-C₁₂-alkyl” is used to denote a C₁-C₁₂-alkyl radical substituted with 1-3 groups selected from the group consisting of the following: halogen, hydroxy, cyano, carboxy, succinimido, glutarimido, phthalimidino, phthalimido, 2-pyrrolidono, C₃-C₈-cycloalkyl, aryl, acrylamido, α-benzoicsulfimido, —SO₂N(R₁₃)R₁₄, —CON(R₁₃)R₁₄, R₁₃CON(R₁₄)—, R₁₅SO₂—, R₁₅O—, R₁₅S—, R₁₅SO₂N(R₁₃)—, —OCON(R₁₃)R₁₄, —CO₂R₁₃, R₁₃CO—, R₁₃OCO₂—, R₁₃CO₂—, aryl, heteroaryl, heteroarylthio, and groups having formula VII: 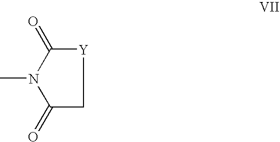
wherein:
Y is selected from the group consisting of C₂-C₄-alkylene; —O—, —S—, —CH₂O— and —N(R₁₃)—;
R₁₃ and R₁₄ are selected from the group consisting of hydrogen, C₁-C₆-alkyl, C₃-C₈-cycloalkyl, C₃-C₈-alkenyl, and aryl;
R₁₅ is selected from the group consisting of C₁-C₆-alkyl, C₃-C₈-cycloalkyl, C₃-C₈-alkenyl and aryl.

The term “C₁-C₆-alkyl” is used to denote straight or branched chain hydrocarbon radicals and these optionally substituted, unless otherwise specified, with 1-2 groups selected from hydroxy, halogen, carboxy, cyano, aryl, aryloxy, arylthio, C₃-C₈-cycloalkyl, C₁-C₆-alkoxy, C₁-C₆-alkylthio; C₁-C₆-alkylsulfonyl; arylsulfonyl; C₁-C₆-alkoxycarbonyl, and C₁-C₆-alkanoyloxy.

The terms “C₁-C₆-alkoxy”, “C₁-C₆-alklythio”, “C₁-C₆-alkylsulfonyl”, “C₁-C₆-alkoxycarbonyl”, “C₁-C₆-alkoxycarbonyloxy”, “C₁-C₆-alkanoyl”, and “C₁-C₆-alkanoyloxy” denote the following structures, respectively: —OC₁—C₆-alkyl, —S—C₁—C₆-alkyl, —O₂S—C₁-C₆-alkyl, —CO₂—C₁-C₆-alkyl, —OCO₂C₁-C₆-alkyl, —OC—C₁-C₆-alkyl, and —OCO—C₁-C₆-alkyl wherein the C₁-C₆-alkyl groups may optionally be substituted with 1-2 groups selected from hydroxy, cyano, aryl, —OC₁-C₄-alkyl, —OCOC₁-C₄-alkyl and —CO₂C₁-C₄-alkyl, wherein the C₁-C₄-alkyl portion of the groups represents a saturated straight or branched chain hydrocarbon radical that contains one to four carbon atoms.

The terms “C₃-C₈-cycloalkyl” and “C₃-C₈-alkenyl” are used to denote saturated cycloaliphatic radicals and straight or branched chain hydrocarbon radicals containing at least one carbon-carbon double bond, respectively, with each radical containing three to eight carbon atoms.

The terms “C₁-C₁₂-alkylene”, “C₂-C₆-alkylene” and “C₁-C₂-alkylene” denote straight or branched chain divalent hydrocarbon radicals containing one to twelve, two to six, and one to two carbon atoms, respectively, and these optionally substituted with one or two groups selected from hydroxy, halogen, aryl and C₁-C₆-alkanoyloxy.

The term “C₃-C₈-alkenylene” is used to denote a divalent straight or branched chain hydrocarbon radical that contains at least one carbon-carbon double bond and with each radical containing three to eight carbon atoms.

The term “C₃-C₈-cycloalkylene” denotes a C₃ to C₈ divalent hydrocarbon radical having from three to eight carbon atoms, optionally substituted with one or two groups selected from hydroxy, halogen, aryl and C₁-C₆-alkanoyloxy.

In the terms “aryl”, “aryloxy”, “arylthio”, arylsulfonyl” and “aroyl” the aryl groups or aryl portions of the groups are selected from phenyl and naphthyl and these optionally substituted with hydroxy, halogen, carboxy, C₁-C₆-alkyl, C₁-C₆-akoxy and C₁-C₆-alkoxycarbonyl.

In the terms “heteroaryl” and “heteroarylthio” the heteroaryl groups or heteroaryl portions of the groups are mono or bicyclo heteroaromatic radicals containing at least one hetero atom selected from oxygen, sulfur and nitrogen or a combination of these atoms, in combination with carbon to complete the aromatic ring. Examples of suitable heteroaryl groups include: furyl, thienyl, benzothiazoyl, thiazolyl, isothiazolyl, pyrazolyl, pyrrolyl, thiadiazolyl, oxadiazolyl, benzoxazolyl, benzimidazolyl, pyridyl, pyrimidinyl and triazolyl and such groups substituted with 1-2 groups selected from C₁-C₆-alkyl, C₁-C₆-alkoxy, C₃-C₈-cycloalkyl, cyano, halogen, carboxy, C₁-C₆-alkoxycarbonyl, aryl, arylthio, aryloxy and C₁-C₆-alkylthio.

The term “halogen” is used to include fluorine, chlorine, bromine and iodine.

The term “carbamoyl” is used to represent the group having the formula: —CON(R₁₃)R₁₄, wherein R₁₃ and R₁₄ are as previously defined.

The term “arylene” is used to represent 1,2-; 1,3-: 1,4-phenylene and these radicals optionally substituted with 1-2 groups selected from C₁-C₆-alkyl, C₁-C₆-alkoxy and halogen.

The above divalent linking groups L₁ and L₂ can be selected from a variety of divalent hydrocarbon moieties including: C₁-C₁₂-alkylene, —(CHR′CHR″O—)ₚCH₂CH₂—, C₃-C₈-cycloalkylene, —CH₂—C₃-C₈-cycloalkylene —CH₂— and C₃-C₈-alkenylene. The C₁-C₁₂ alkylene linking groups may contain within their main chain heteroatoms, e.g. oxygen, sulfur and nitrogen and substituted nitrogen (—N(R₁₃)—), wherein R₁₃ is as previously defined, and/or cyclic groups such as C₃-C₈-cycloalkylene, arylene, divalent heteroaromatic groups or ester groups such as:

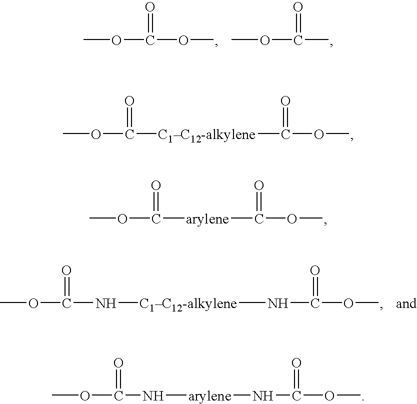

Some of the cyclic moieties which may be incorporated into the C₁-C₁₂-alkylene chain of atoms include:

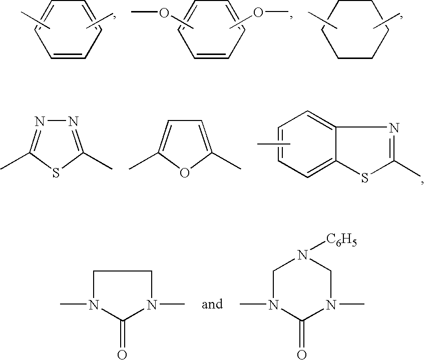

The skilled artisan will understand that each of the references herein to groups or moieties having a stated range of carbon atoms such as C₁-C₄-alkyl, C₁-C₆-alkyl, C₁-C₁₂-alkyl, C₃-C₈-cycloalkyl, C₃-C₈-alkenyl, C₁-C₁₂-alkylene, C₂-C₆-alkylene, and the like include moieties of all of the number of carbon atoms mentioned within the ranges. For example, the term “C₁-C₆-alkyl” includes not only the C₁ group (methyl) and C₆ group (hexyl) end points, but also each of the corresponding C₂, C₃, C₄, and C₅ groups including all isomers. In addition, it will be understood that each of the individual points within a stated range of carbon atoms may be further combined to describe subranges that are inherently within the stated overall range. For example, the term “C₃-C₈-cycloalkyl” includes not only the individual cyclic moieties C₃ through C₈, but also contemplates subranges such as C₄-C₆-cycloalkyl.

The term “polyester reactive group” is used herein to describe a group which is reactive with at least one of the functional groups from which the polyester is prepared under polyester forming conditions. Example of such groups are hydroxy, carboxy, C₁-C₆-alkoxycarbonyl, C₁-C₆-alkoxycarbonyloxy and C₁-C₆-alkanoyloxy.

The level of UV absorber added as a component of any of these embodiments is dependent on the application for which the polyester product is intended, the level of UV exposure expected, the sensitivity of any article enclosed by the polyester to UV light, the molar extinction coefficient of the specific UV absorber chosen, the thickness of the article to be prepared from the polyester, the nature of the other additives present in the polyester; including any colorants, opacifiers, catalyst residues, reheat agents, nucleators, de-nesting agents, slip agents etc. whether added prior to the polymerization, during the polymerization or post-polymerization, and the composition of the polyester repeat unit among other factors. Generally, for most packaging applications, the expected level of UV absorber required would be between 0 and 5 wt. % based on the weight of polymer; more preferably between 0.001 and 2 wt. % based on the weight of polymer. These ranges stated are given for illustrative purposes only and are not intended to limit the scope of the present invention.

The polymerization is carried out such that the reaction pressure in the first chamber is from about 20 to 50 psi and the reaction pressure in the last reaction chamber is from about 0.1 mm Hg to about 2 mm Hg. The pressure in the intermediate reactor is successively dropped with the reaction pressure in each of the one or more intermediate reactor being between 50 psi and 0.1 mm Hg. The reaction temperature in each reaction chamber is from about 200° C. to about 300° C.

The reaction mixture used in the method of the invention includes a diol component. Preferably, the diol component is a glycol. Suitable diols include, for example, diols selected from the group consisting of ethylene glycol, 1,4-cyclohexanedimethanol, 1,2-propanediol, 1,3-propanediol, 1,4-butanediol, 2,2-dimethyl-1,3-propanediol, 1,6-hexanediol, 1,2-cyclohexanediol, 1,4-cyclohexanediol, 1,2-cyclohexanedimethanol, 1,3-cyclohexanedimethanol, 2,2,4,4-tetramethyl-1,3-cyclobutane diol; X,8-bis(hydroxymethyl)tricyclo-[5.2.1.0]-decane wherein X represents 3, 4, or 5, and diols containing one or more oxygen atoms in the chain, e.g., diethylene glycol, triethylene glycol, dipropylene glycol, tripropylene glycol and the like containing from about 2 to about 18, preferably 2 to 12 carbon atoms in each aliphatic moiety. Cycloaliphatic diols can be employed in their cis or trans configuration or as mixtures of both forms. More preferably, the diol comprises a component selected from the group consisting of ethylene glycol, diethylene glycol, 1,4-cyclohexanedimethanol, or mixtures thereof. In many cases, the diol may comprise a major amount of ethylene glycol and modifying amounts cyclohexanedimethanol and/or diethylene glycol.

The reaction mixture also includes a diacid component selected from the group consisting of aliphatic, alicyclic, or aromatic dicarboxylic acids and esters of such dicarboxylic acids. Suitable diacid components are selected from the group consisting of terephthalic acid, naphthalene dicarboxylic acid, isophthalic acid, 1,4-cyclohexanedicarboxylic acid, 1,3-cyclohexanedicarboxylic acid, succinic acid, glutaric acid, adipic acid, sebacic acid, 1,12-dodecanedioic acid, and the like; and esters of these dicarboxylic acids. In the polymer preparation, it is often preferable to use a functional acid derivative thereof such as the dimethyl, diethyl, or dipropyl ester of the dicarboxylic acid. The anhydrides of these acids also can be employed. Preferably, the diacid component comprises a dicarboxylic acid ester. More preferably, the diacid component is terephthalic acid or dimethyl terephthalate. Most preferably, the diacid component comprises dimethyl terephthalate. The molar ratio of the diol component to the diacid component is from about 0.5 to about 4. More preferably, the molar ratio of the diol component to the diacid component is from about 1 to about 3. Most preferably, the ratio of the diol to the diacid component is about 2.

The reaction mixture further comprises a component containing a metal selected from the group consisting of zinc, manganese, and mixtures thereof, antimony containing component, and a phosphorus containing component. Typically, the metal containing component is zinc acetate or manganese acetate, the antimony containing component is antimony trioxide, and the phosphorus containing component is phosphoric acid or an alkyl ester thereof. Preferably, the metal containing component is zinc acetate and is present in an amount from about 10 to about 200 ppm, the antimony trioxide is present in an amount from about 20 to about 500 ppm, and phosphorous is present in an amount from about 5 to about 200 ppm.

The reaction mixture optionally includes one or more components selected from the group consisting of an iron containing compound, a toner, a cobalt containing compound, and mixtures thereof. For example, the reaction mixture and the polyester compositions of the invention may contain black iron oxide in an amount ranging from 1 ppm to 50 ppm, or 1 ppm to 10 ppm.

In another embodiment of the present invention, a method of incorporating a UV absorber in a polyester composition with or without a titanium containing ester exchange catalyst is provided. The method of this embodiment comprises forming a reaction mixture comprising a diol, a diacid component selected from the group consisting of dicarboxylic acids, dicarboxylic acid derivatives, and mixtures thereof in a polycondensation reaction system. The polycondensation reaction system comprises a series of reaction chambers. For purposes of differentiating each of the reaction chambers, each chamber may be assigned a label RCⁱ. Accordingly, each chamber is designatable as reaction chamber RCⁱ. The polycondensation system has a first reaction chamber designatable as reaction chamber RC¹, a last reaction chamber designatable as reaction chamber RC^{k}, and one or more intermediate reaction chambers. As used herein, i and k are integers, and k is the total number of reaction chambers. The polycondensation system is operated in series such that a reaction product designatable as product Pⁱ from reaction chamber RCⁱ is directly or indirectly transportable to reaction chamber RCⁱ⁺¹ by a conduit designatable as conduit Cⁱ connecting reaction chamber RCⁱ to reaction chamber RCⁱ⁺¹ (i.e., the polymerization product from each reaction chamber is transported to the next reaction chamber in the series). As used herein, “indirectly transportable” recognizes that the product from reaction chamber RCⁱ can be physically disconnected from reaction chamber RCⁱ⁺¹ but still provide feed stock to the reaction chamber, such as via tanker truck or rail car. However, for sake of brevity, it is assumed herein that such reaction chambers and conduits are in fluid communication, but the scope of the invention includes both direct and indirect product transfer. Accordingly, the reaction mixture is successively polymerized as it proceeds through the polycondensation system. Preferably, the UV absorber is added to reaction product P^{k-2} while reaction product P^{k-2} is transported between reaction chamber RC^{k-2} and reaction chamber RC^{k-1} (i.e., the UV absorber is added in the conduit connecting third from the last to the second from the last reaction chamber.) The UV absorbers, the diol, and the diacid component are the same as set forth above with the same amounts as set forth above. The UV absorber may be added neat or in a carrier such as the same or different diol used in RC¹. By feeding the UV absorber into the conduit, it is possible to increase the yield of the UV absorber in the polyester composition. Without being bound to a theory, it is believed that by feeding the UV absorber into the conduit, the UV absorber has a sufficient residence time to dissolve into the melt, or be absorbed onto the polymer, or otherwise remain in the melt in contrast with adding the UV absorber to reaction chamber which typically operates under conditions promoting loss of the UV absorber as it is carried off with the flashing of the diol. In this embodiment, the reaction is preferably conducted in the presence of 0.0 to 5 ppm titanium containing ester exchange catalysts, more preferably using 0.0 ppm titanium containing compounds.

In yet another embodiment of the present invention, a titanium free polyester composition is provided. Preferably, the polyester composition is made by any one of the methods of the invention. The titanium free polyester composition of this embodiment comprises a diol residue, as diacid residue, a UV absorber residue, antimony atoms present in an amount of less than 0.1%; phosphorus atoms present in an amount of less than about 0.1%; metal atoms selected from the group consisting of zinc, manganese, and mixtures thereof in an amount from about 5 ppm to about 300 ppm; and titanium atoms present in an amount ranging from 0.0 to 5 ppm. By a titanium free polyester composition is meant one which contains from 0.0 to 5 ppm titanium metal. The UV absorber residue is the residue of the UV absorber set forth above. More preferably, the antimony atoms are present in an amount from about 20 to about 500 ppm and the phosphorus atoms are present in an amount from about 10 to about 200 ppm and the composition contains 2 ppm, most preferably 0.0 ppm titanium metal.

The diacid residue is preferably selected from the group consisting of dicarboxylic acid residues, dicarboxylic acid derivative residues, and mixtures thereof. More preferably, the diacid residue is a dicarboxylic acid ester residue. Most preferably, the diacid residue is a dimethyl terephthalate residue. The diol residue is preferably a glycol residue. The diol residue is selected from the group consisting of ethylene glycol residue, diethylene glycol residue, 1,4-cyclohexanedimethanol residue, and mixtures thereof. The ratio of the diol residues to the diacid residues is from about 0.5 to about 4. Moreover, the polyester composition of the present invention has less than about 20 meq/g of carboxyl ends.

One skilled in the art will understand that various thermoplastic articles can be made from the polyester of the present invention where excellent UV protection of the contents would be important. Examples of such articles includes bottles, storage containers, sheets, films, fibers, plaques, hoses, tubes, syringes, and the like. Basically, the possible uses for polyester having a low-color, low-migratory UV absorber is voluminous and cannot easily be enveloped.

### EXAMPLE 1

### Synthesis of Compound VI

Cyanoacetic acid (200 g, 2.35 mols), pentaerythritol (53.39 g, 0.392 mols), 500 mL of toluene, and p-toluenesulfonic acid monohydrate (2.67 g) were added to a clean 2 L flask equipped with a mechanical stirrer, thermocouple, and a reflux condenser. The reaction mixture was heated with stirring to 105° C. until water distillation stops at which time approximately 28 mL of water was collected. The reaction mixture was allowed to cool to room temperature and the toluene layer was decanted. To the remaining oil was added 1 L of ethyl acetate and the mixture was stirred until a solution was obtained. Water (500 mL) was added to the stirring reaction mixture followed by sodium bicarbonate (50 g, 0.6 mols) is several small quantities to neutralize any remaining acids. The mixture was transferred into a separatory funnel and the water layer was separated and discarded. Neutralization with aqueous sodium bicarbonate was repeated until the aqueous washes were basic. The ethyl acetate layer was washed twice with 200 mL of water and twice with 200 mL of brine solution then dried over anhydrous MgSO₄, filtered and concetrated to give about 100 g of a light yellow oil. The identity of the product was confirmed by mass spectrometry. The resulting oil (10.0 g, 24.75 mmols), 2-furaldehyde (9.75 g, 101.5 mmols), piperidine acetate (147 mg, 1.01 mmols) and 150 mL of anhydrous ethanol were added to a 250 mL round bottomed flask equipped with a magnetic stir bar. The reaction mixture was stirred at ambient temperature for about 50 h. The product, the compound of Formula VI above, was precipitated by the slow addition of 750 mL of deionized water with stirring. The solid was collected by suction filtration and washed with 200 mL of deionized water followed by 50 mL of methanol and allowed to dry on the filter overnight to give about 12 grams of the product as a pale yellow solid. The UV absorbing compound VI exhibited a wavelength of maximum absorbance (λₘₐₓ) at 342 nm. The molar extinction coefficient (ε) was determined to be 90,596.

### EXAMPLE 2

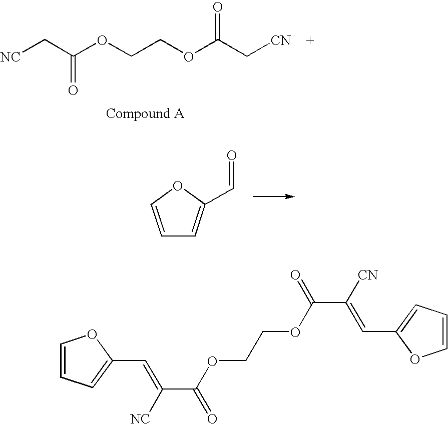

Compound A was first prepared in accordance with U.S. Pat. No. 5,532,332. To a 250 mL round bottom flask equipped with a magnetic stirrer and heating mantle were added the following reactants and in the amounts specified below:

| Reactant | Amount | |
|---|---|---|
| Compound A | 8.13 | grams |
| 2-furaldehyde* | 8.49 | grams |
| anhydrous ethanol | 70 | mL |
| piperidine acetate | 1.28 | grams |

*Available from Aldrich Chemical

The reaction mixture was then heated to 60° C. for about one hour while stirring. The reaction mixture was allowed to cool to room temperature and crystals formed upon cooling. Water was added to further precipitate the product. The precipitate was collected by suction filtration and washed with 100 mL of water followed by 20 mL of cold methanol. The cake was allowed to dry on the filter overnight to give about 10 g of an off white solid. The product identity was confirmed using flame desorption mass spectrometry (FD-MS).

### EXAMPLE 3

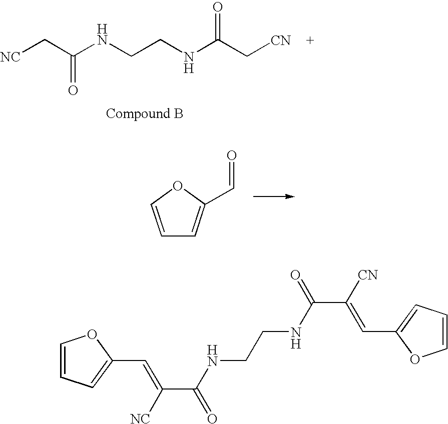

Compound B was first prepared in accordance with U.S. Pat. No. 5,532,332. To a 250 mL round bottom flask equipped with a magnetic stirrer and heating mantle were added the following reactants and in the amounts specified below:

| Reactant | Amount |
|---|---|
| Compound B | 6.0 grams |
| 2-furaldehyde | 5.94 grams |
| anhydrous ethanol | 50 mL |
| sodium methoxide in methanol | 0.5 mL of 25 wt. % |

The reaction mixture was stirred at room temperature until complete according to TLC analysis (less than 1 hour). The product was precipitated by adding 250 mL of water. The precipitate was collected by suction filtration and washed with 200 mL of water followed by 20 mL of cold methanol. The cake was allowed to dry on the filter overnight to give 8.52 g of an off white solid. The product identity was confirmed using flame desorption mass spectrometry (FD-MS).

### EXAMPLE 4

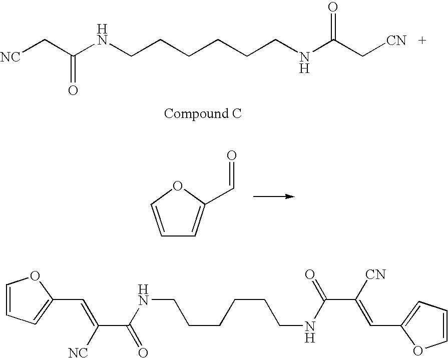

Compound C was first prepared in accordance with U.S. Pat. No. 5,532,332. To a 250 mL round bottom flask equipped with a magnetic stirrer and heating mantle were added the following reactants and in the amounts specified below:

| Reactant | Amount |
|---|---|
| Compound C | 10.0 grams |
| 2-furaldehyde | 7.69 grams |
| anhydrous ethanol | 100 mL |
| sodium methoxide in methanol | 0.5 mL of 25 wt. % |

The reaction mixture was stirred at room temperature until complete according to TLC analysis (less than 1 hour). The product was precipitated by adding 750 mL of water. The precipitate was collected by suction filtration and washed with 200 mL of water followed by 20 mL of cold methanol. The cake was allowed to dry on the filter overnight to give 12.71 g of an off white solid. The product identity was confirmed using flame desorption mass spectrometry (FD-MS).

Having described the invention in detail, those skilled in the art will appreciate that modifications may be made to the various aspects of the invention without departing from the scope and spirit of the invention disclosed and described herein. It is, therefore, not intended that the scope of the invention be limited to the specific embodiments illustrated and described but rather it is intended that the scope of the present invention be determined by the appended claims and their equivalents. Moreover, all patents, patent applications, publications, and literature references presented herein are incorporated by reference in their entirety for any disclosure pertinent to the practice of this invention.

1. A method of incorporating a UV absorber into a polyester resin, the method comprising:
a) forming a reaction mixture substantially free of a titanium containing ester exchange catalyst compound and comprising:
a diol,
a diacid component selected from the group consisting of dicarboxylic acids, dicarboxylic acid derivatives, and mixtures thereof,
an antimony containing compound in an amount of less than 0.1% of the total weight of the reaction mixture,
a phosphorus containing compound present in an amount of less than about 0.1% of the total weight of the reaction mixture,
a metal containing compound selected from the group consisting of zinc containing compounds, manganese containing compounds, present in an amount from about 10 ppm to about 300 ppm, and
a UV absorbing compound, wherein said UV absorbing compound comprises at least one furyl-2-methylidene radical of Formula I: 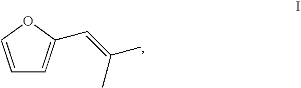
wherein the UV absorbing compound includes a polyester reactive group; and
b) polymerizing the reaction mixture in a polycondensation reaction system, the polycondensation reaction system having a first reaction chamber, a last reaction chamber, and one or more intermediate reaction chambers between the first reaction chamber and the last reaction chamber, wherein the reaction system is operated in series such that the reaction mixture is progressively polymerized in the first reaction chamber, the one or more intermediate reactions, and the last reaction chamber.

2. The method of claim 1 wherein the UV absorber is selected from the group consisting of compounds represented by Formulae II and III: 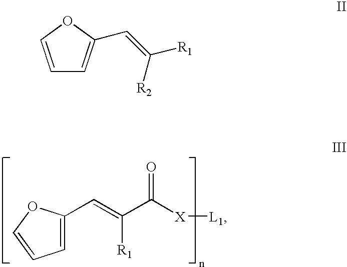
wherein:
X is selected from the group consisting of oxygen, —NH—, and —N(R′)—;
n is a whole number ranging from 2 to 4;
R₁ is selected from the group consisting of —CO₂R₃ and cyano;
R₂ is selected from the group consisting of cyano, —CO₂R₃, C₁-C₆-alkylsulfonyl, arylsulfonyl, carbamoyl, C₁-C₆-alkanoyl, aroyl, aryl, and heteroaryl;
R₃ is selected from the group consisting of hydrogen, C₁-C₁₂-alkyl, substituted C₁-C₁₂-alkyl, —(CHR′—CHR″O—)ₚCH₂CH₂R₄, C₃-C₈-alkenyl, C₃-C₈-cycloalkyl, aryl and cyano, wherein p is an integer of from 1 to 100;
R₄ is selected from the group consisting of hydrogen, hydroxy, C₁-C₆-alkoxy, C₁-C₆-alkanoyloxy and aryloxy;
R′ and R″ are independently selected from hydrogen and C₁-C₁₂-alkyl;
L₁ is a di, tri, or tetravalent linking group, where the divalent radical is selected from the group consisting of C₂-C₁₂-alkylene, —(CHR′CHR″O—)ₚCHR′CHR″—, C₁-C₂-alkylene-arylene-C₁-C₂-alkylene, —CH₂CH₂O-arylene-OCH₂CH₂—, and —CH₂-1,4-cyclohexylene-CH₂—; wherein p is an integer from 1 to 100, and wherein the trivalent and tetravalent radicals are selected from the group consisting of C₃-C₈ aliphatic hydrocarbon having three or four covalent bonds.

3. The method of claim 2 wherein said UV absorbing compound is selected from the group consisting of compounds represented by the Formulae IV-VI: 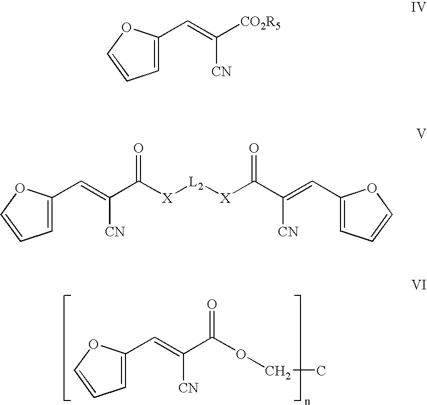
wherein:
R₅ is selected from the group consisting of C₁-C₆-alkyl, cyclohexyl, phenyl, and —(CHR′CHR″O—)ₚR₆, wherein p is an integer from 1 to 100;
R₆ is selected from hydrogen, C₁-C₆-alkoxy, and C₁-C₆-alkanoyloxy; and
L₂ is selected from the group consisting of C₂-C₆-alkylene, —(CHR′CHR″O—)ₚCHR′CHR″—, and —CH₂-cyclohexane-1,4-diyl-CH₂—, wherein p is an integer from 1 to 100.

4. The method of claim 1 wherein from 0.0 to 2 ppm titanium metal is added the reaction mixture.

5. The method of claim 1 wherein the polymerization with each reaction chamber having a reaction pressure such that the reaction pressure in the first chamber is from about 20 to 50 psi and the reaction pressure in the last reaction chamber is from about 0.1 mm Hg to about 2 mm Hg with the reaction pressure in each of the one or more intermediate reactor being between 50 psi and 0.1 mm Hg.

6. The method of claim 1 wherein from 0.0 ppm titanium metal is added to the reaction mixture.

7. The method of claim 1 wherein the diol component is selected from the group consisting of ethylene glycol; 1,4-cyclohexanedimethanol; 1,2-propanediol; 1,3-propanediol; 1,4-butanediol; 2,2-dimethyl-1,3-propanediol; 1,6-hexanediol; 1,2-cyclohexanediol; 1,4-cyclohexanediol; 1,2-cyclohexanedimethanol; 1,3-cyclohexanedimethanol; 2,2,4,4-tetramethyl-1,3-cyclobutane diol; X,8-bis(hydroxymethyl)tricyclo-[5.2.1.0]-decane, wherein X represents 3, 4, or 5; and diols containing one or more oxygen atoms in a chain and mixtures thereof.

8. The method of claim 1 wherein the diacid component comprises a component selected from the groups consisting of terephthalic acid, isophthalic acid, naphthalene dicarboxylic acid, 1,4-cyclohexanedicarboxylic acid, 1,3-cyclohexanedicarboxylic acid, succinic acid, glutaric acid, adipic acid, sebacic acid, 1,12-dodecanedioic acid, and esters of said acids; and mixtures thereof.

9. The method of claim 8 wherein the diacid component comprises dimethyl terephthalate.

10. The method of claim 1 wherein the molar ratio of the diol component to the diacid component is from about 0.5 to about 4.

11. The method of claim 1 wherein the reaction mixture further comprises a component containing a metal selected from the group consisting of zinc, manganese, and mixtures thereof, an antimony containing component, and a phosphorus containing component.

12. The method of claim 11 wherein the metal containing component is zinc acetate or manganese acetate, the antimony containing component is antimony trioxide, and the phosphorus containing component is phosphoric acid.

13. The method of claim 12 wherein the metal containing component is zinc acetate present in an amount from about 10 to about 200 ppm.

14. The method of claim 12 wherein the antimony trioxide is present in an amount from about 20 to about 500 ppm.

15. The method of claim 12 wherein the phosphoric acid is present in an amount from about 5 to about 200 ppm.

16. The method of claim 1 further comprising one or more components selected from the group consisting of an iron containing compound, a toner, a cobalt containing compound, and mixtures thereof.

17. The method of claim 2 or 3 wherein said alkoxylated moiety represented by the formula —(CHR′CHR″O—)ₚ is selected from the group consisting of ethylene oxide residues, propylene oxide residues, or residues of both, and p is less than about 50.

18. The method of claim 17 wherein p is less than 8.

19. The method of claim 17 wherein p is from 1-3.

20. A method of incorporating a UV absorber into a polyester resin, the method comprising:
a) forming a reaction mixture comprising combining:
a diol,
a diacid component selected from the group consisting of dicarboxylic acids, dicarboxylic acid derivatives, and mixtures thereof in a polycondensation reaction system comprising a series of reaction chambers designatable as reaction chamber RCⁱ having a first reaction chamber designatable as reaction chamber RC¹, a last reaction chamber designatable as reaction chamber RC^{k}, and one or more intermediate reaction chambers
b) successively polymerizing the reaction mixture in the multi-chamber reaction polymerization system wherein the reaction system is operated in series such that a reaction product designatable as product Pⁱ from reaction chamber RCⁱ is transportable to reaction chamber RCⁱ⁺¹ by a conduit designatable as conduit Cⁱ connecting reaction chamber RCⁱ to a reaction chamber RCⁱ⁺¹; and
c) adding the UV absorber to reaction product Pⁱ as it is transported from reaction chamber RCⁱ to reaction chamber RCⁱ⁺¹, wherein i and k are integer and k is the total number of reaction chambers.

21. The method of claim 20 wherein the UV absorber comprises at least one furyl-2-methylidene radical of Formula I: 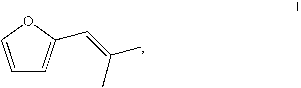
wherein the UV absorbing compound includes a polyester reactive group.

22. The method of claim 21 wherein the UV absorber is selected from the group consisting of compounds represented by Formulae II and III: 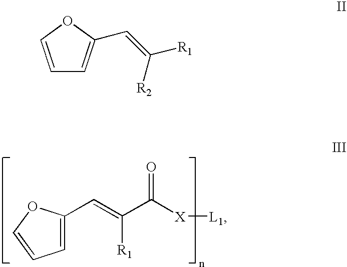
wherein:
X is selected from the group consisting of oxygen, —NH—, and —N(R′)—;
n is a whole number ranging from 2 to 4;
R₁ is selected from the group consisting of —CO₂R₃ and cyano;
R₂ is selected from the group consisting of cyano, —CO₂R₃, C₁-C₆-alkylsulfonyl, arylsulfonyl, carbamoyl, C₁-C₆-alkanoyl, aroyl, aryl, and heteroaryl;
R₃ is selected from the group consisting of hydrogen, C₁-C₁₂-alkyl, substituted C₁-C₁₂-alkyl, —(CHR′—CHR″O—)ₚCH₂CH₂R₄, C₃-C₈-alkenyl, C₃-C₈-cycloalkyl, aryl and cyano, wherein p is an integer of from 1 to 100;
R₄ is selected from the group consisting of hydrogen, hydroxy, C₁-C₆-alkoxy, C₁-C₆-alkanoyloxy and aryloxy;
R′ and R″ are independently selected from hydrogen and C₁-C₁₂-alkyl;
L₁ is a di, tri, or tetravalent linking group, where the divalent radical is selected from the group consisting of C₂-C₁₂— alkylene, —(CHR′CHR″O—)ₚCHR′CHR″—, C₁-C₂-alkylene-arylene-C_{-C}₂-alkylene, —CH₂CH₂O-arylene-OCH₂CH₂—, and —CH₂-1,4-cyclohexylene-CH₂—; wherein p is an integer from 1 to 100, and wherein the trivalent and tetravalent radicals are selected from the group consisting of C₃-C₈ aliphatic hydrocarbons having three or four covalent bonds.

23. The method of claim 22 wherein said UV absorbing compound is selected from the group consisting of compounds represented by the Formulae IV-VI: 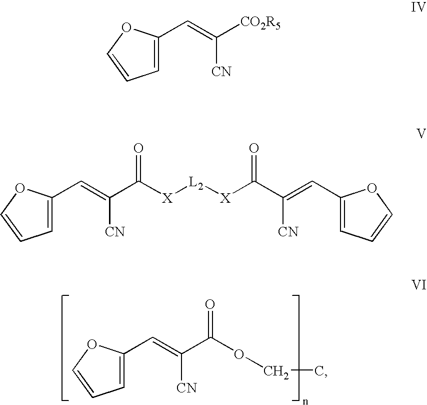
wherein:
R₅ is selected from the group consisting of C₁-C₆-alkyl, cyclohexyl, phenyl, and —(CHR′CHR″O—)ₚR₆, wherein p is an integer from 1 to 100;
R₆ is selected from hydrogen, C₁-C₆-alkoxy, and C₁-C₆-alkanoyloxy; and
L₂ is selected from the group consisting of C₂-C₆-alkylene, —(CHR′CHR″O—)ₚCHR′CHR″—, and —CH₂-cyclohexane-1,4-diyl-CH₂—, wherein p is an integer from 1 to 100.

24. The method of claim 21 wherein the UV absorber is added to reaction product P^{k-2} while reaction product P^{k-2} is transported between reaction chamber RC^{k-2} and reaction chamber RC^{k-1}.

25. The method of claim 21 wherein from 0.0 to 2 ppm titanium metal is added to the reaction mixture.

26. The method of claim 21 wherein the diol component is selected from the group consisting of ethylene glycol; 1,4-cyclohexanedimethanol; 1,2-propanediol; 1,3-propanediol; 1,4-butanediol; 2,2-dimethyl-1,3-propanediol; 1,6-hexanediol; 1,2-cyclohexanediol; 1,4-cyclohexanediol; 1,2-cyclohexanedimethanol; 1,3-cyclohexanedimethanol; 2,2,4,4-tetramethyl-1,3-cyclobutane diol; X,8-bis(hydroxymethyl)tricyclo-[5.2.1.0]-decane, wherein X represents 3, 4, or 5; diols containing one or more oxygen atoms in a chain and mixtures thereof.

27. The method of claim 21 wherein the diacid component comprises a component selected from the groups consisting of terephthalic acid, isophthalic acid, naphthalene dicarboxylic acid, 1,4-cyclohexanedicarboxylic acid, 1,3-cyclohexanedicarboxylic acid, succinic acid, glutaric acid, adipic acid, sebacic acid, 1,12-dodecanedioic acid, and esters of said acids, and mixtures thereof.

28. The method of claim 27 wherein the diacid component comprises dimethyl terephthalate.

29. The method of claim 27 wherein the molar ratio of the diol component to the diacid component is from about 0.5 to about 4.

30. The method of claim 21 wherein the reaction mixture further comprises a component containing a metal selected from the group consisting of zinc, manganese, and mixtures thereof, an antimony containing component, and a phosphorus containing component.

31. The method of claim 30 wherein the metal containing component is zinc acetate or manganese acetate, the antimony containing component is antimony trioxide, and the phosphorus containing component is phosphoric acid.

32. The method of claim 31 wherein the metal containing component is zinc acetate present in an amount from about 10 to about 200 ppm.

33. The method of claim 31 wherein the antimony trioxide is present in an amount from about 20 to about 500 ppm.

34. The method of claim 31 wherein the phosphoric acid is present in an amount from about 5 to about 200 ppm.

35. The method of claim 20 further comprising one or more components selected from the group consisting an iron containing compound, a toner, a cobalt containing compound, and mixtures thereof.

36. The method of claim 20, wherein 0.0 ppm titanium metal is added to the reaction mixture.

37. The method of claim 22 or 23 wherein said alkoxylated moiety represented by the formula —(CHR′CHR″O—)ₚ is selected from the group consisting of ethylene oxide residues, propylene oxide residues, or residues of both, and p is less than about 50.

38. The method of claim 37 wherein p is less than 8.

39. The method of claim 37 wherein p is from 1-3.

40. A polyester composition comprising:
diacid residues;
diol residues;
UV absorber residues from a UV absorber having Formula I: 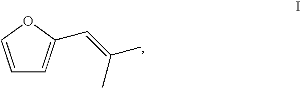
and wherein the UV absorbing compound includes a polyester reactive group;
antimony atoms present in an amount of less than 0.1%;
phosphorus atoms present in an amount of less than about 0.1%;
metal atoms selected from the group consisting of zinc, manganese, and mixtures thereof in an amount from about 10 ppm to about 300 ppm; and
optionally titanium atoms present in an amount of 0.0 to 5 ppm.

41. The polyester composition of claim 40 wherein the UV absorber is selected from the group consisting of compounds represented by Formulae II and III: 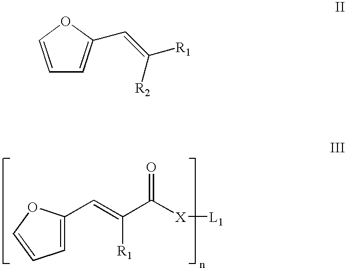
wherein:
X is selected from the group consisting of oxygen, —NH—, and —N(R′)—;
n is a whole number ranging from 2 to 4;
R₁ is selected from the group consisting of —CO₂R₃ and cyano;
R₂ is selected from the group consisting of cyano, —CO₂R₃, C₁-C₆-alkylsulfonyl, arylsulfonyl, carbamoyl, C₁-C₆-alkanoyl, aroyl, aryl, and heteroaryl;
R₃ is selected from the group consisting of hydrogen, C₁-C₁₂-alkyl, substituted C₁-C₁₂-alkyl, —(CHR′—CHR″O—)ₚCH₂CH₂R₄, C₃-C₈-alkenyl, C₃-C₈-cycloalkyl, aryl and cyano, wherein p is an integer of from 1 to 100;
R₄ is selected from the group consisting of hydrogen, hydroxy, C₁-C₆-alkoxy, C₁-C₆-alkanoyloxy and aryloxy;
R′ and R″ are independently selected from hydrogen and C₁-C₁₂-alkyl;
L₁ is a di, tri, or tetravalent linking group, where the divalent radical is selected from the group consisting of C₂-C₁₂-alkylene, —(CHR′CHR″O—)ₚCHR′CHR″—, C₁-C₂-alkylene-arylene-C₁-C₂-alkylene, —CH₂CH₂O-arylene-OCH₂CH₂—, and —CH₂-1,4-cyclohexylene-CH₂—; wherein p is an integer from 1 to 100, and wherein the trivalent and tetravalent radicals are selected from the group consisting of C₃-C₈ aliphatic hydrocarbons having three or four covalent bonds.

42. The polyester composition of claim 41 wherein said UV absorbing compound is selected from the group consisting of compounds represented by the Formulae IV-VI: 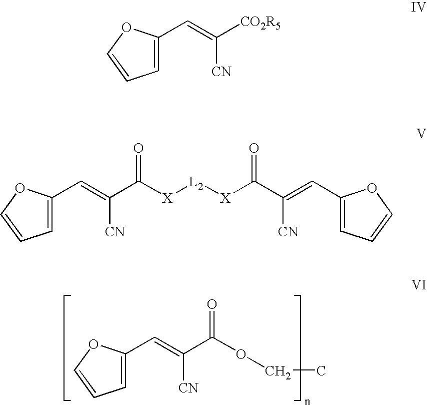
wherein:
R₅ is selected from the group consisting of C₁-C₆-alkyl, cyclohexyl, phenyl, and —(CHR′CHR″O—)ₚR₆, wherein p is an integer from 1 to 100;
R₆ is selected from hydrogen, C₁-C₆-alkoxy, and C₁-C₆-alkanoyloxy; and
L₂ is selected from the group consisting of C₂-C₆-alkylene, —(CHR′CHR″O—)ₚCHR′CHR″—, and —CH₂-cyclohexane-1,4-diyl-CH₂—, wherein p is an integer from 1 to 100.

43. The polyester composition of claim 40 wherein the diacid residue is selected from the group consisting of dicarboxylic acid residues, dicarboxylic acid derivative residues, and mixtures thereof.

44. The polyester composition of claim 43 wherein the diacid residue is a dicarboxylic acid ester residue.

45. The polyester composition of claim 43 wherein the diacid residue is a dimethyl terephthalate residue.

46. The polyester composition of claim 40 wherein the diol residue comprises a glycol residue.

47. The polyester composition of claim 40 wherein the diol residue component is selected from the group consisting of a residue of ethylene glycol; 1,4-cyclohexanedimethanol; 1,2-propanediol; 1,3-propanediol; 1,4-butanediol; 2,2-dimethyl-1,3-propanediol; 1,6-hexanediol; 1,2-cyclohexanediol; 1,4-cyclohexanediol; 1,2-cyclohexanedimethanol; 1,3-cyclohexanedimethanol; 2,2,4,4-tetramethyl-1,3-cyclobutane diol; X,8-bis(hydroxymethyl)tricyclo-[5.2.1.0]-decane, wherein X represents 3, 4, or 5; diols containing one or more oxygen atoms in a chain and mixtures thereof.

48. The polyester composition of claim 40 wherein the diacid residue comprises a component selected from the group consisting of residues of terephthalic acid, naphthalene dicarboxylic acid, isophthalic acid, 1,4-cyclohexanedicarboxylic acid, 1,3-cyclohexanedicarboxylic acid, succinic acid, glutaric acid, adipic acid, sebacic acid, 1,12-dodecanedioic acid, esters of said acids, and mixtures thereof.

49. The polyester composition of claim 40 wherein the molar ratio of the diol residues to the diacid residues is from about 0.5 to about 4.

50. The polyester composition of claim 40 having less than about 20 meq/g of carboxyl ends.

51. The polyester composition of claim 40 wherein the antimony atoms are present in an amount from about 20 to about 500 ppm.

52. The polyester composition of claim 40 wherein the phosphorus atoms are present in an amount from about 10 to about 200 ppm.

53. The polyester composition of claim 40 wherein the amount of titanium metal added to the polyester is 0.0 ppm.

54. The polyester composition of claim 40, further comprising black iron oxide.

55. The polyester composition of claim 54, wherein the amount of black iron oxide ranges from 1 ppm to 10 ppm.

56. A thermoplastic article prepared from the polyester of claim 40.

57. A thermoplastic article prepared from the polyester of claim 42.

58. A thermoplastic article prepared from the polyester of claim 43.

59. The thermoplastic article of claim 56, 57 or 58 wherein said article is selected from the group consisting of bottles, storage containers, sheets, films, plaques, hoses, tubes, and syringes.

60. The thermoplastic article of claim 57 or 58 wherein said alkoxylated moiety represented by the formula —(CHR′CHR″O—)ₚ is selected from the group consisting of ethylene oxide residues, propylene oxide residues, or residues of both, and p is less than about 50.

61. The thermoplastic article of claim 60 wherein p is less than 8.

62. The thermoplastic article of claim 60 wherein p is from 1-3.

63. A UV absorbing compound having the general Formula: 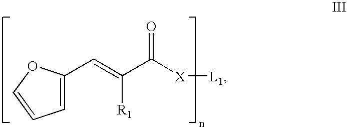
wherein:
X is selected from the group consisting of oxygen, —NH—, and —N(R′)—;
n is a whole number ranging from 2 to 4;
R₁ is selected from the group consisting of —CO₂R₃ and cyano;
R₃ is selected from the group consisting of hydrogen, C₁-C₁₂-alkyl, substituted C₁-C₁₂-alkyl, —(CHR′—CHR″O—)ₚCH₂CH₂R₄, C₃-C₈-alkenyl, C₃-C₈-cycloalkyl, aryl and cyano;
R₄ is selected from the group consisting of hydrogen, hydroxy, C₁-C₆-alkoxy, C₁-C₆-alkanoyloxy and aryloxy;
R′ and R″ are independently selected from hydrogen and C₁-C₁₂-alkyl;
L₁ is a di, tri, or tetravalent linking group, where the divalent radical is selected from the group consisting of C₂-C₁₂-alkylene, —(CHR′CHR″O—)ₚCHR′CHR″—, C₁-C₂-alkylene-arylene-C₁-C₂-alkylene, —CH₂CH₂O-arylene-OCH₂CH₂—, and —CH₂-1,4-cyclohexylene-CH₂—; where the trivalent and tetravalent radicals are selected from the group consisting of C₃-C₈ aliphatic hydrocarbon having three or four covalent bonds.

64. The UV absorbing compound of claim 63 wherein the UV absorbing compound is selected from the group of compounds having the general formulae: 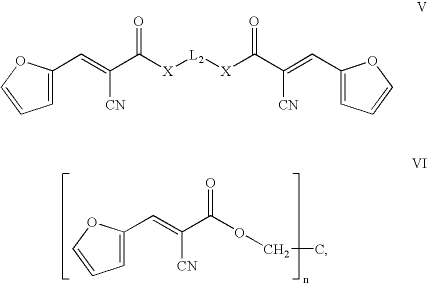
wherein:
X is selected from the group consisting of oxygen, —NH—, and —N(R′)—;
n is 2; and
L₂ is selected from the group consisting of C₂-C₆-alkylene, —(CHR′CHR″O—)ₚCHR′CHR″—, and —CH₂-cyclohexane-1,4-diyl-CH₂—.
